(19) United States
(12) Patent Application Publication
(10) Pub. No.: US 2008/0164669 A1
(43) Pub. Date: Jul. 10, 2008

(54) LPG tank and cart therefor

(75) Inventor: Robert M. Stone, Tucson, AZ (US)

Correspondence Address: ANTONIO R. DURANDO, 6902 N. TABLE MOUNTAIN ROAD, TUCSON, AZ, 85718-1331, US

(73) Assignee: BISHAMON INDUSTRIES CORPORATION, ONTARIO (CA)

(21) Appl. No.: 11/650,742

(22) Filed: Jan. 8, 2007

(51) Int. Cl. B62B 1/00

(52) U.S. Cl. 280/79.5

(57) ABSTRACT

A cart is clamped to a tank for liquid propane gas and has a height which is a minor fraction of the height of the tank. In projections of the cart and the carriage on a plane normal to the longitudinal axis of the tank, no more than a minor fraction of the projection of the cart is located outside the projection of the tank.

### BACKGROUND OF THE INVENTION

1. Field of the Invention

The invention relates to the handling of containers for fluid.

2. Description of the Prior Art

Forklift trucks are fueled by tanks of liquid propane gas (LPG) which are placed in cradles mounted on the trucks. When a tank runs dry, the tank is replaced by a full tank. The dry tank is taken to a storage location of the facility in which the forklift trucks operate, and the dry tank is subsequently trucked from this storage location to a facility for refilling tanks of this type. The refilled tank is returned to the storage location to await renewed use.

There is usually no warning when a tank runs dry, and the forklift truck on which the tank is mounted will generally not be at the storage location when this occurs. It is then necessary to transport the dry tank from the forklift truck to the storage location and to transport a full tank from the storage location to the forklift truck. Although the tanks can be carried manually, this can be cumbersome. It is therefore preferable to transport the tanks on the 2-wheeled dollies which are normally present in facilities employing forklift trucks. However, a 2-wheeled dolly is not always available when a tank runs dry.

### SUMMARY OF THE INVENTION

One aspect of the invention resides in a carriage. The carriage comprises a gripping member defining an opening for receipt of a selected part of an article to be gripped. The gripping member extends circumferentially of the opening and is elastically deformable between an expanded condition and a contracted condition. The opening has a first size in the expanded condition which is sufficiently large for the selected part of the article to enter the opening, and the opening has a second size smaller than the first size in the contracted condition. The second size is selected such that the gripping member grips the selected part of the article when the selected part is received in the opening and the gripping member is in the contracted condition. The carriage further comprises at least one rolling member, e.g., a wheel or caster, and means for rotatably mounting the rolling member on the gripping member.

The gripping member can have two ends which are spaced from one another by a first distance in the expanded condition of the gripping member and by a smaller second distance in the contracted condition of the gripping member. The mounting means may here include at least one bearing member attached to the gripping member in the region of one of its ends. The bearing member is provided with an aperture, and the mounting means further includes a shaft receivable in the aperture and designed to support the rolling member for rotation.

The mounting means may include an additional bearing member attached to the gripping member in the region of the second end of the gripping member, and the additional bearing member is provided with an additional aperture designed to receive the support shaft.

Each of the bearing members has a side facing away from the other of the bearing members. The support shaft can have a length which exceeds the distance between the bearing members in the expanded condition of the gripping member so that a portion of the shaft projects to each of the above sides when the shaft is received in the apertures of the bearing members. The carriage can comprise an additional rolling member, and each rolling member may be mountable on a respective projecting shaft portion.

The mounting means may comprise means for urging the gripping member from the expanded condition to the contracted condition. The urging means can include a sleeve for each projecting shaft portion, and each such sleeve has a length smaller than the length of the corresponding shaft portion. Each of the sleeves is designed to abut a respective bearing member when the sleeves are mounted on the projecting shaft portions. Each rolling member is receivable on a respective sleeve and has a width smaller than the length of the associated sleeve. The urging means further includes an abutment, e.g., a washer, receivable on each of the projecting shaft portions and designed to bear against the respective sleeve.

The urging means can also include a locking member receivable on each of the projecting shaft portions for locking the sleeves, the rolling elements and the abutments on the shaft portions. These locking members are designed to bear against the abutments.

An additional sleeve may be receivable on the support shaft between the bearing members. This additional sleeve preferably has a length at least approximating the distance between the bearing members in the contracted condition of the gripping member. Under such circumstances, the bearing members may bear against the additional sleeve in the contracted condition of the gripping member.

The carriage can further comprise a foot designed to cooperate with the rolling members in supporting the gripping member on a surface.

The carriage may also be provided with a carrier for adjustably holding the foot on the gripping member. The carrier and the foot can be provided with cooperating threaded portions for adjusting the position of the foot on the gripping member.

The carriage may additionally comprise a locking member for locking the foot in different positions on the gripping member.

The foot and the rolling members are advantageously made of rubber, preferably hard rubber, to cushion the gripping member when the carriage is placed on a surface.

The gripping member can include a metallic element having a major surface which faces the opening in the gripping member. A deformable rubber element may be affixed to such major surface to adjust the gripping member to the part of the article received in the opening.

The gripping member can be in the form of a band which is part-circular in the expanded condition of the gripping member.

Another aspect of the invention resides in a manually transportable arrangement. The arrangement comprises a container for fluid, e.g., liquid propane gas, and the container is movable between an upright position and a lying position. The arrangement further comprises a carriage for the container. The carriage includes a gripping member defining an opening which receives part of the container, and the gripping member grips such part of the container. The carriage additionally includes rolling means, e.g., one or more wheels or casters, for rolling the carriage and means rotatably mounting the rolling means on the gripping member. The container and the carriage are designed so that, while the gripping member grips the part of the container received in the opening of the gripping member, the container can be in its lying position with all of the carriage, or all of the carriage except for the rolling means, free of contact with all objects other than the container.

The gripping member can be removable from the part of the container received by the gripping member. The gripping member may comprise a band which is part-circular when the gripping member is removed from such part of the container.

The part of the container received by the gripping member can be a base for supporting the container on a surface when the container is in its upright position. The base has a first end and an opposite second end which is spaced from the first end by a predetermined distance, and the container may have an additional part which defines a shoulder with one end of the base. The gripping member here advantageously has a length, as considered in a direction from one end of the base towards the other, which is at most equal to the distance between the base ends. The gripping member can abut the shoulder defined by the base and the additional part of the container.

The carriage preferably extends along a minor fraction, i.e., less than one-half, of the height of the container.

The container may be elongated and have a longitudinal axis, and the container and carriage then each have a projection in a plane normal to the longitudinal axis of the container. Under these conditions, it is preferred that at most a minor fraction of the projection of the carriage be located externally of the projection of the container.

An additional aspect of the invention resides in a method of manipulating a container for fluid.

One embodiment of the method comprises the steps of providing a carriage, securing the carriage to the container, and utilizing fluid from the container while the carriage remains secured to the container. The utilizing step involves the withdrawal of fluid from the container, and the instant embodiment of the method further comprises the step of transporting the container on the carriage following withdrawal of a quantity of fluid from the container. The container is transported to a storage location, and the present embodiment of the method then comprises the additional step of storing the container at the storage location while the carriage remains secured to the container.

The container may accommodate liquid propane gas and, in such an event, the step of utilizing fluid from the container can involve use of the liquid propane gas as fuel for a vehicle.

The container can be movable between an upright position and a lying position.

Another embodiment of the method comprises the steps of providing a carriage having rolling means for rolling the carriage, securing the carriage to the container and positioning the container at a predetermined location in its lying position. This embodiment of the method further comprises the step of maintaining all of the carriage, or all of the carriage except for the rolling means, substantially free of contact with all objects other than the container while the container is in the lying position at the predetermined location.

Additional features and advantages of the invention will be forthcoming from the following detailed description of certain specific embodiments when read in conjunction with the accompanying drawings.

### BRIEF DESCRIPTION OF THE DRAWINGS

FIG. 1 is a side view showing a carriage according to the invention supporting a container for fluid in an upright position.

FIG. 2 is a bottom view of the carriage and container of FIG. 1.

FIG. 3 is an exploded view of the carriage of FIG. 1.

FIG. 4 is a side view showing the carriage and container of FIG. 1 lying on a surface with the carriage out of contact with the surface.

FIG. 5 is a side view showing the carriage and container of FIG. 1 lying on a surface with the carriage contacting the surface.

FIG. 6 is a side view showing the carriage and container of FIG. 1 in an inclined position.

### DESCRIPTION OF THE PREFERRED EMBODIMENTS

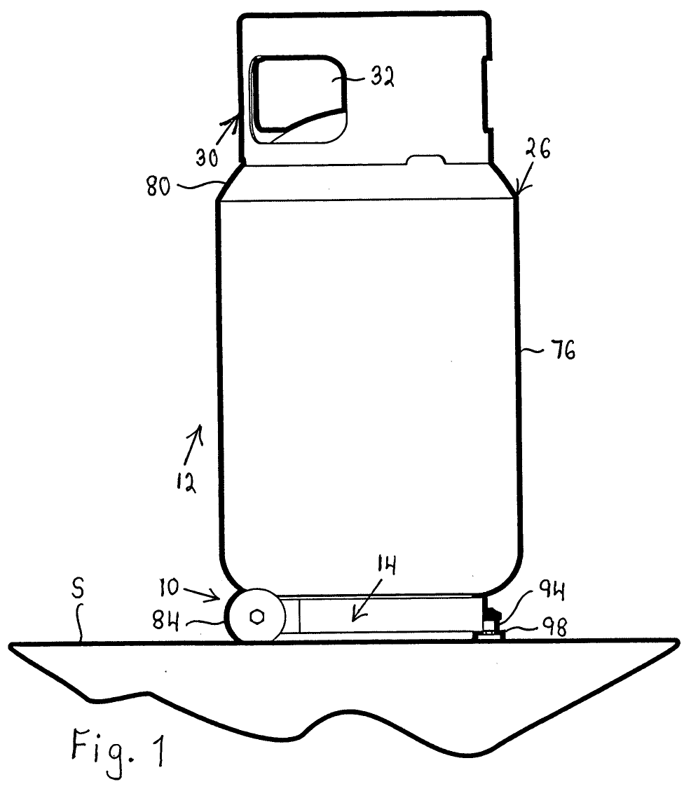

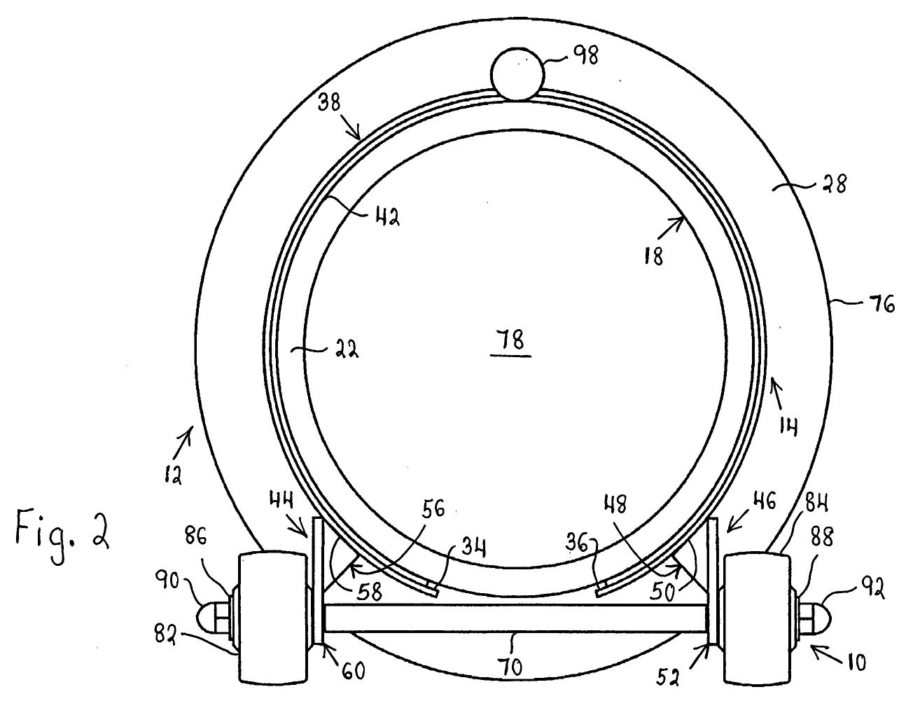

Referring to FIGS. 1 and 2, the numeral 10 identifies a cart or carriage in accordance with the invention. The cart 10 is secured to an elongated container or vessel 12 which accommodates fluid under pressure, and the container or vessel 12 is assumed to be a conventional tank for liquid propane gas. The tank 12 is here of the type used to fuel vehicles, e.g., forklifts. The cart 10 is designed for manual transportation of the tank 12.

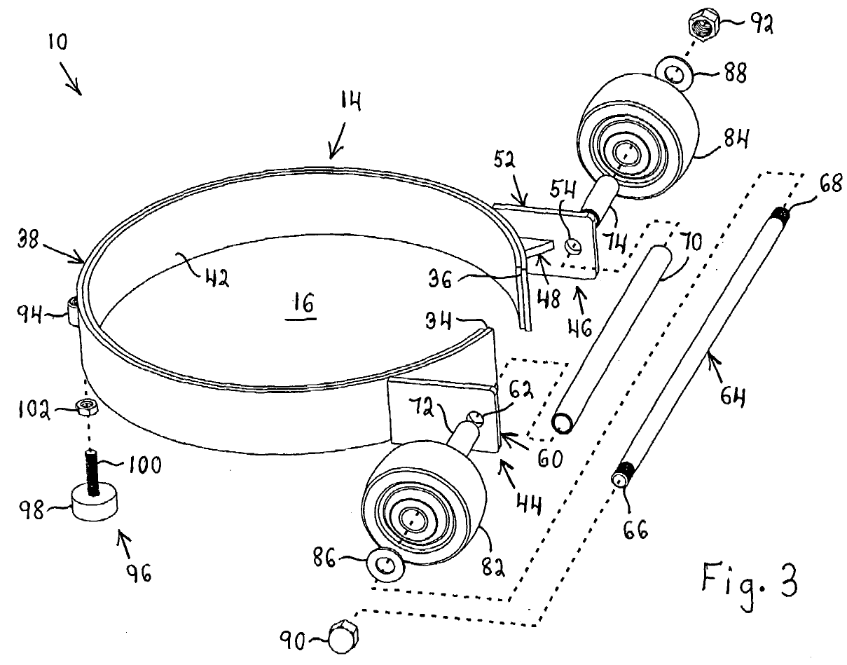

Considering FIG. 3 in conjunction with FIGS. 1 and 2, the cart 10 includes a clamping member or gripping member 14 in the form of a band or a strip. The clamping member 14 is elastically or resiliently deformable between an expanded condition shown in FIG. 3 and a contracted condition shown in FIGS. 1 and 2. The terms “elastically deformable” and “resiliently deformable” mean that the clamping member 14 can undergo deformation discernible by the human senses without the aid of instruments and thereafter return to its condition preceding deformation.

The clamping member 14 defines an opening 16 for receipt of a part 18 of the tank 12. The part 18 is here a base of the tank 12, and the tank base 18 is in the form of a slightly tapered, hollow frustum of a cone. The tank base 18 has a free axial end 20 provided with an edge 22 on which the tank 12 rests when the tank 12 is in an upright position shown in FIG. 1 and the base 18 is placed on a surface. The tank base 18 also has another axial end which is spaced from and disposed opposite the free base end 20. This other axial end of the tank base 18, which is invisible in the drawings because the clamping member 14 overlies such axial end, is attached to an additional part 26 of the tank 12. The tank base 18 converges slightly in a direction from the free base end 20 to the invisible attached base end so that the free base end 20 has a slightly larger diameter than the attached base end.

The additional part 26 of the tank 12 includes a cylinder 76 of circular cross section having an end adjacent to the tank base 18 and an opposite end remote from the tank base 18. The end of the cylinder 76 adjacent to the tank base 18 is closed by a generally circular end wall 78 while the other end of the cylinder 76 is closed by a dome 80. The additional part 26 of the tank 12 contains the liquid propane gas carried by the tank 12. The end wall 78 of the gas-containing tank part 26 has a diameter which exceeds the diameter of the invisible attached base end, and the end wall 78 and attached base end together define a shoulder 28 circumscribing the attached base end. The clamping member 14 can abut the shoulder 28 when the clamping member 14 clamps the tank-base 18.

The tank 12 has another part 30 which is fast with the dome 80 of the gas-containing tank part 26, and this last part 30 of the tank 12 is in the form of an annular collar or wall provided with one or more cutouts 32. The cutouts 32 can serve as handholds, among other things. The collar 30 surrounds non-illustrated items typically found on liquid propane tanks for fueling vehicles, and such items include a service valve, a relief valve, a fill port and a gauge.

The tank 12 has a longitudinal axis, and the tank base 18, the gas-containing tank part 26 and the tank collar 30 are coaxial and each have a longitudinal axis lying on that of the tank 12. The collar 30 has a diameter smaller than that of the gas-containing tank part 26, and the collar 30 and gas-containing tank part 26 define a sloping shoulder facing away from the annular shoulder 28 adjacent to the tank base 18.

The tank 12 is typically made of aluminum or steel, and the dimensions of the tank base 18 depend upon which of these materials is used for the tank 12. If the tank 12 is composed of aluminum, the outer diameter of the tank base 18 at the free base end 20 is in the range of about 9.41 to 9.42. inches while the outer diameter at the invisible attached base end is in the range of about 9.32 to 9.39 inches. For steel, the outer diameter of the tank base 18 at the free base end 20 is about 10.30 inches and the outer diameter at the invisible attached base end is about 10.15 inches. The height of the tank base 18, that is, the distance between the free base end 20 and the invisible attached base end, is the same whether the tank 12 is made of aluminum or steel and is about 1.9 to 2.0 inches.

The clamping member 14 is part-circular in the expanded condition of the clamping member 14 and very nearly part-circular in the contracted condition thereof. The clamping member 14 has two ends 34 and 36 which face one another and, in the contracted condition of the clamping member 14, are spaced from each other by a smaller distance than in the expanded condition of the clamping member 14. Consequently, the opening 16 defined by the clamping member 14 has a smaller area or size in the contracted condition of the clamping member 14 than in the expanded condition thereof. In the expanded condition of the clamping member 14, the opening 16 is sufficiently large that the tank base 18 can enter the opening 16. When the clamping member 14 is in the contracted condition, the area of the opening 16 is so much smaller than the area in the expanded condition that the clamping member 14 clamps or grips the tank base 18 if the latter is in the opening 16.

The clamping member 14 includes a metallic layer or element 38 in the form of a band or strip. The metallic layer 38, which preferably consists of aluminum or an aluminum alloy, is part-circular in the expanded condition of the clamping member 14 and very nearly part-circular in the contracted condition thereof. The metallic layer 38 has a major surface which faces the opening 16 of the clamping member 14, and a deformable layer or element 42 in the form of a band or strip is secured to such major surface. The deformable layer 42, which is advantageously composed of rubber, is again part-circular in the expanded condition of the clamping member 14 and very nearly part-circular in the contracted condition of the clamping member 14. The metallic layer 38 can be referred to as an outer layer of the clamping member 14 whereas the deformable layer 42 can be referred to as an inner layer of the clamping member 14.

The inner layer 42 can, for instance, be adhesively bonded to the outer layer 38.

The length of the inner layer 42 as considered circumferentially of the clamping member 14 is preferably equal or nearly equal to the length of the outer layer 38. Similarly, it is preferred for the height of the inner layer 42 to be equal or nearly equal to the height of the outer layer 38. The length of the inner layer 42 is here slightly smaller than that of the outer layer 38 while the height of the inner layer 42 equals the height of the outer layer 38.

The height of the clamping member 14 is at most equal to the height of the tank base 18. This allows the clamping member 14 to clamp the tank base 18 without projecting beyond the free base end 20.

The deformable inner layer 42 allows the clamping member 14 to adjust to the contour of the tank base 18.

A bracket or bearing member 44 is mounted on the outer layer 38 of the clamping member 14 in the region of the clamping member end 34. Similarly, a bracket or bearing member 46 is mounted on the outer layer 38 in the region of the clamping member end 36. The two brackets 44,46 are identical and only the bracket 46 will be described.

The bracket 46 includes a generally triangular plate 48 having an edge 50 with a curvature matching that of the outer layer 38 of the clamping member 14. The plate 48 lies in a plane perpendicular to the axis of the clamping member 14, and the curved edge 50 of the plate 48 confronts the outer layer 38 and runs circumferentially thereof. The curved edge 50 of the plate 48 is bonded to the outer layer 38.

The triangular plate 48 of the bracket 46 has a flat edge which is located in a plane paralleling the axis of the clamping member 14, and the bracket 46 includes a generally rectangular plate 52 which is fixed to this flat edge of the triangular plate 48. The rectangular plate 52 again lies in a plane which is parallel to the axis of the clamping member 14. One of the longitudinal ends of the rectangular plate 52 is situated adjacent to the outer layer 38 of the clamping member 14 and is bonded to the outer layer 38.

Considering the expanded condition of the clamping member 14, the outer layer 38 of the clamping member 14 is part-circular as mentioned previously. The outer layer 38 has a major surface facing away from the inner layer 42 of the clamping member 14, and this major surface of the outer layer 38 lies on a circle. A portion of the rectangular plate 52 of the bracket 46 projects beyond the clamping member 14 in a direction from the center of such circle through a point of the circle midway between the ends 34,36 of the clamping member 14. This projecting portion of the rectangular plate 52 is provided with an aperture 54.

The triangular plate of the second bracket 44 mounted on the clamping member 14 is identified by the numeral 56 and the curved edge of the triangular plate 56 is identified by the numeral 58. The rectangular plate of the bracket 44 is identified by the numeral 60 and the aperture in the rectangular plate 58 is identified by the numeral 62.

The heights of the brackets 44,46 are preferably such that the brackets 44,46 do not project beyond the clamping member 14 as considered in the axial direction of the clamping member 14.

In addition to the clamping member 14, the cart 10 includes an axle or shaft 64 having externally threaded ends 66 and 68. The axle 64, which has a circular cross section, fits in the apertures 62,54 of the brackets 44,46 with clearance. The length of the axle 64 exceeds the distance between the rectangular plates 60,52 of the brackets 44,46. The axle 64 is sufficiently long that, when the axle 64 passes through the apertures 62,54 of the brackets 44,46, a portion of the axle 64 can project to the side of the bracket 44 facing away from the bracket 46 while a portion of the axle 64 projects to the side of the bracket 46 facing away from the bracket 44. When the axle 64 is properly positioned on the brackets 44,46, one of the projecting portions of the axle 64 includes the externally threaded end 66 plus an adjoining unthreaded part of the axle 64 while the other projecting portion includes the externally threaded end 68 plus an adjoining unthreaded part of the axle 64.

The cart 10 further includes a sleeve 70, a sleeve 72 and a sleeve 74 which fit on the axle 64 with clearance and are in the form of hollow cylinders of circular cross section. The sleeve 70 is designed to be located on the portion of the axle 64 between the brackets 44,46 of the clamping member 14. The length of the sleeve 70 is somewhat less than the distance between the brackets 44,46 in the expanded condition of the clamping member 14 and equal to the distance between the brackets 44,46 in the contracted condition of the clamping member 14. The outer diameter of the sleeve 70 exceeds the diameters of the apertures 62,54 in the brackets 44,46 thereby enabling the brackets 44,46 to bear against the sleeve 70 in the contracted condition of the clamping member 14.

The two sleeves 72,74 are shorter than the sleeve 70. As just indicated, the axle 64 has two portions which project to the exterior of the space between the brackets 44,46 when the axle 64 is properly positioned on the brackets 44,46, and each of the short sleeves 72,74 is designed to sit on a respective one of these projecting axle portions. It was also pointed out that each of the projecting axle portions includes a respective externally threaded end 66,68 of the axle 64 plus an adjoining unthreaded part of the axle 64. The short sleeves 72,74 are shorter than the projecting axle portions and somewhat longer than the unthreaded parts of the projecting axle portions. As a result, the short sleeves 72,74 will extend over the threaded axle ends 66,68 when the short sleeves 72,74 sit on the projecting axle portions. The outer diameters of the short sleeves 72,74 are greater than the diameters of the apertures 62,54 in the brackets 44,46 so that the short sleeves 72,74 can bear against the brackets 44,46 in the contracted condition of the clamping member 14. The outer diameters of the short sleeves 72,74 can be the same as the outer diameter of the long sleeve 70.

The cart 10 additionally includes two rolling members 82 and 84 which can be constituted by wheels or casters. The rolling members 82,84 are designed to sit on respective ones of the short sleeves 72,74 and have respective axial passages of circular cross section. These axial passages have diameters greater than the outer diameters of the short sleeves 72,74 thereby enabling the rolling members 82,84 to be received on the short sleeves 72,74 with clearance. The widths of the rolling members 82,84 are smaller than the lengths of the short sleeves 72,74. The rolling members 82,84 are preferably made of hard rubber to cushion the tank 12 when the cart 10 is placed on a surface while clamping the tank 12.

The cart 10 also includes two washers or abutments 86 and 88 which are designed to sit on respective ones of the threaded axle ends 66,68. The washers 86,88 are provided with respective axial passages of circular cross section, and such axial passages have diameters greater than those of the threaded axle ends 66,68 and smaller than the outer diameters of the short sleeves 72,74. Since the diameters of the axial passages in the washers 86,88 are smaller than the outer diameters of the short sleeves 72,74, the washers 86,88 can bear against the short sleeves 72,74 in the contracted condition of the clamping member 14.

The cart 10 further includes two cap nuts or locking members 90 and 92 which are designed to screw onto the threaded axle ends 66,68.

A gap separates the ends 34,36 of the clamping member 14, and an internally threaded, annular boss or carrier 94 is situated diametrically opposite this gap. As noted earlier, the outer layer 38 of the clamping member 14 has a major surface facing away from the inner layer 42, and the annular boss 94 is secured to this major surface.

An adjusting member 96 is provided for the cart 10 and comprises a bumper or foot 98 in the form of a circular disk. The bumper 98 has opposed, flat major surfaces, and an externally threaded rod 100 projects from one of these major surfaces perpendicular thereto. The externally threaded rod 100 is designed to screw into the annular boss 94. When the clamping member 14 clamps the tank base 18, the externally threaded rod 100 is oriented such that the rod 100 screws into the annular boss 94 in a direction from the tank base 18 towards the collar 30 of the tank 12.

If the cart 10 is placed on a supporting surface and the externally threaded rod 100 is received by the annular boss 94, the major surface of the bumper 98 opposite that with the externally threaded rod 100 can come to rest on the supporting surface. The portion of the clamping member 14 in the vicinity of the annular boss 94 can be positioned at different heights above the supporting surface by screwing the externally threaded rod 100 into the annular boss 94 to a lesser or greater extent.

A jam nut or locking member 102 can be screwed onto the externally threaded rod 100. Once the externally threaded rod 100 has been screwed into the annular boss 94 to the desired extent, the jam nut 102 is brought into abutment with and tightened against the annular boss 94. The jam nut 102 then locks the threaded rod 100 against rotation thereby fixing the portion of the clamping member 14 in the vicinity of the annular boss 94 at a set height above the supporting surface for the cart 10.

One manner of assembling the cart 10 and mounting the cart 10 on the tank base 18 is as follows:

The long sleeve 70 is placed between the brackets 44,46 and oriented with the longitudinal axis thereof at least approximately in register with the axes of the apertures 62,54 of the brackets 44,46. The externally threaded end 66 of the axle 64 is passed through the aperture 54 in the bracket 46 from the side of the bracket 46 facing away from the bracket 44. The externally threaded end 66 of the axle 64 is thereupon successively passed through the long sleeve 70 and the aperture 62 of the bracket 44. The axle 64 is positioned so that a portion of the axle 64 projects to the side of the bracket 46 facing away from the bracket 44 and a portion of the axle 64 projects to the side of the bracket 44 facing away from the bracket 46. The projecting portions of the axle 64 respectively include the externally threaded end 66 and the externally threaded end 68 of the axle 64 as well as adjoining unthreaded parts of the axle 64.

The short sleeve 72 is slid onto the portion of the axle 64 which comprises the externally threaded end 66 of the axle 64 and projects to the side of the bracket 44 facing away from the bracket 46. Thereafter, the rolling member 82 is slid onto the short sleeve 72, the washer 86 is slid onto the externally threaded end 66 of the axle 64 and the cap nut 90 is loosely screwed onto the threaded end 66.

The short sleeve 74 is now slid onto the portion of the axle 64 which projects to the side of the bracket 46 facing away from the bracket 44 and includes the externally threaded end 68 of the axle 64. The rolling member 84 is then slid onto the short sleeve 74, the washer 88 is slid onto the externally threaded end 68 of the axle 64 and the cap nut 92 is loosely screwed onto the threaded end 68.

If not done previously, the jam nut 102 is screwed onto the externally threaded rod 100 of the adjusting member 96 and the threaded rod 100 is screwed into the boss 94.

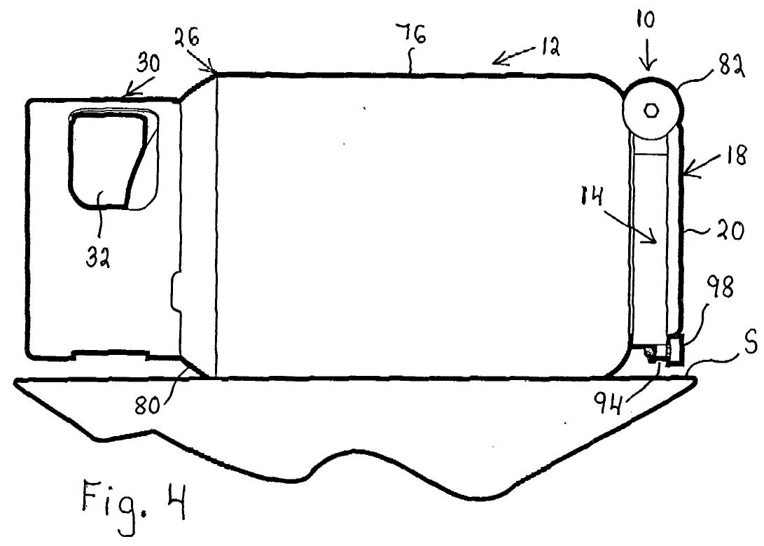

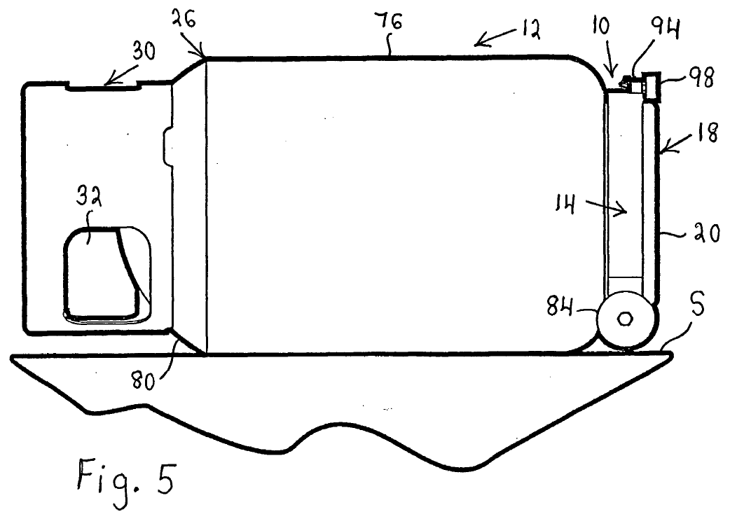

At this time, the clamping member 14 is in its expanded condition and the opening 16 of the clamping member 14 is sufficiently large to receive the tank base 18. The tank 12 is placed on its side so that it is in the lying position shown in FIGS. 4 and 5. The clamping member 14 is thereupon slipped onto the tank base 18 in an orientation such that the major surface of the bumper 98 facing away from the externally threaded rod 100 also faces away from the gas-containing part 26 of the tank 12. The clamping member 14 is advantageously pushed against the shoulder 28 defined by the tank base 18 and the gas-containing tank part 26.

Once the clamping member 14 is properly positioned on the tank base 18, the cap nuts 90,92 are tightened. As the cap nuts 90,92 are tightened, the cap nut 90 pushes the washer 86 against the short sleeve 72 and the cap nut 92 pushes the washer 88 against the short sleeve 74. Continued tightening of the cap nuts 90,92 causes the washer 86 to push the short sleeve 72 against the rectangular plate 60 of the bracket 44 and causes the washer 88 to push the short sleeve 74 against the rectangular plate 52 of the bracket 46. During further tightening of the cap nuts 90,92, the short sleeves 72,74 urge the brackets 44,46, and hence the ends 34,36 of the clamping member 14, towards one another. Consequently, the clamping member 14 is urged out of its expanded condition and towards its contracted condition. When the cap nuts 90,92 are fully tightened, the brackets 44,46 bear against the long sleeve 70 and the clamping member 14 clamps the tank base 18. The cap nuts 90,92 firmly hold the washers 86,88, the short sleeves 72,74, the brackets 44,46 and the long sleeve 70 together with no slack.

As mentioned previously, the width of each of the rolling members 82,84 is less than the length of the short sleeve 72,74 on which the respective rolling member 82,84 is mounted. Accordingly, the rolling members 82,84 are free to rotate on the respective short sleeves 72,74.

Once the cap nuts 90,92 have been fully tightened, the tank 12 can be placed in its upright position. FIG. 1 shows the cart 10 holding the tank 12 in its upright position on a supporting surface S. If the cart 10 is to be level on the supporting surface S and this is not the case when the tank 12 is brought to its upright position, the bumper 98 is adjusted to level the cart 10.

FIGS. 1, and 4-6 illustrate that the height of the cart 10 is a minor fraction, i.e., less than one-half, of the height of the tank 12. In fact, as considered in a direction from the tank base 18 to the tank collar 30, the cart 10 here terminates substantially at the end of the gas-containing tank part 26 which adjoins the tank base 18. In other words, the cart 10 essentially does not project beyond the tank base 18 as considered in a direction from the tank base 18 to the tank collar 30. Moreover, when the cart 10 and the tank 12 are projected onto a plane normal to the longitudinal axis of the tank 12, it is preferred that no more than a minor fraction of the projection of the cart 10 lies outside the projection of the tank 12. FIG. 2 illustrates that this is the case for the cart 10.

Due to the limited height of the cart 10 and the limited size of a projection of the cart 10 on a plane normal to the longitudinal axis of the tank 12, the cart 10 is quite compact.

Assuming that the cart 10 has been clamped to the tank 12 and that the tank 12 is filled with liquid propane gas and is in its upright position on the cart 10, one manner of using the cart 10 is as follows:

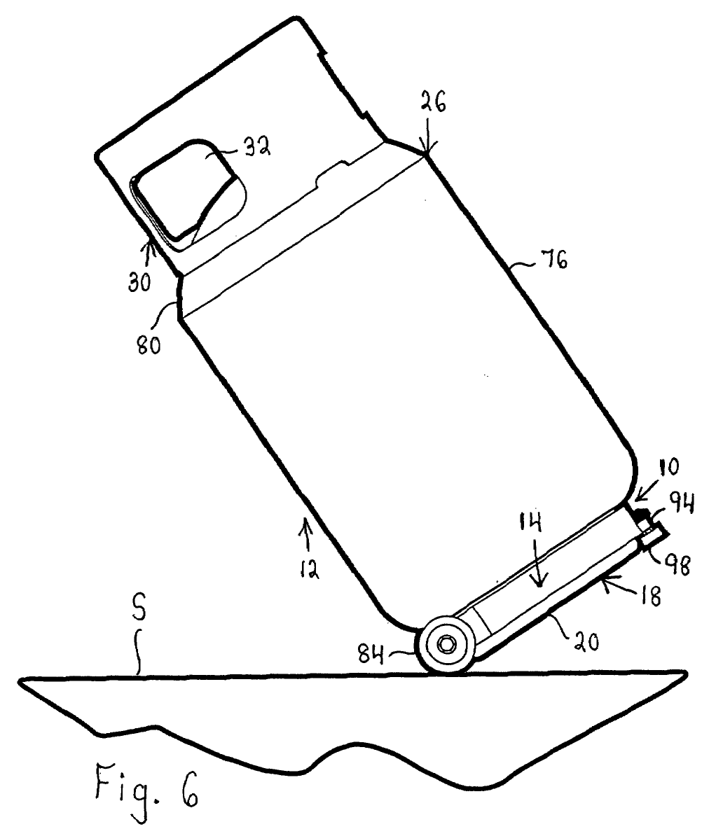

A worker grips the tank 12 by means of appropriate ones of the handholds 32 and tilts the tank 12 on the axis of the axle 64 thereby placing the tank 12 in the inclined position of FIG. 6. The worker now wheels the tank 12 on the cart 10 to a non-illustrated vehicle which is to be fueled with the liquid propane gas in the tank 12. The vehicle is here assumed to be a conventional forklift having a cradle which is designed to accommodate the tank 12 in its lying position. With the cart 10 still clamped to the tank 12, the worker hoists the tank 12 into the cradle and places the tank 12 in its lying position with the cart 10 attached thereto. The tank 12 can be strapped to the cradle in a common manner to secure the tank 12 in the cradle. After the tank 12 has been properly secured, the tank 12 is connected to the fuel system of the forklift in the usual fashion.

The cart 10 remains clamped to the tank 12 during the entire time that the tank 12 is mounted on the forklift. Due to the compactness of the cart 10, the cart 10 may be kept free of contact with the forklift, and all other objects aside from the tank 12, while the latter lies on the forklift. This is illustrated in FIG. 4.

Once the tank 12 has been emptied, the tank 12 is disconnected from the fuel system of the forklift in a known manner. The tank 12 is released from the cradle and a worker lowers the tank 12 to the ground together with the cart 10 clamped thereto. The cart 10 comes to rest on the ground with the tank 12 supported on the cart 10 in its upright position.

The worker grasps appropriate ones of the handholds on the tank 12 and tilts the tank 12 on the axis of the axle 64 to bring the tank 12 into the inclined position. The worker then wheels the tank 12 on the cart 10 to a storage location where, with the cart 10 continuing to clamp the tank 12, the worker places the tank 12 on a cradle in the lying position. Again, the cart 10 can be kept free of contact with all objects other than the tank 12 while the latter lies at the storage location.

From the storage location, the tank 12 is taken to a location for refilling the tank 12. Following refilling of the tank 12, the tank 12 is returned to the storage location and placed in its lying position. Transportation of the tank 12 from the storage location to the refilling location, refilling of the tank 12 and transportation of the tank 12 from the refilling location back to the storage location can be accomplished with the cart 10 remaining clamped to the tank 12.

At some point after the refilled tank 12 has been returned to the storage location, the tank 12 is removed from the storage location and placed in its upright position on the cart 10. The process described above is now repeated with the tank 12 once more being used to fuel a forklift.

As was pointed out above, FIG. 4 shows that the compact nature of the cart 10 allows the tank 12 to be so oriented in its lying position that, when the cart 10 clamps the tank 12, the cart 10 can be kept free of contact with all objects other than the tank 12. With the cart 10 attached to the tank 12, it is also possible to place the tank 12 in its lying position such that all of the cart 10, with the exception of the rolling members 82,84, is free of contact with all objects other than the tank 12. This is illustrated in FIG. 5 where the tank 12 rests on the surface S together with the rolling members 82,84 of the cart 10. The remainder of the cart 10 is free of contact with all objects other than the tank 12. The orientation of the tank 12 and cart 10 shown in FIG. 5 makes it relatively simple to bring the tank 12 from its lying position to its upright position.

Various modifications are possible within the meaning and range of equivalence of the appended claims.

I claim:

1. A carriage comprising:
a gripping member defining an opening for receipt of a selected part of an article to be gripped, said gripping member extending circumferentially of said opening and being elastically deformable between an expanded condition and a contracted condition, and said opening having a first size in said expanded condition which is sufficiently large for the selected part of the article to enter said opening, said opening having a second size smaller than said first size in said contracted condition, and said second size being selected such that said gripping member grips the selected part of the article when the selected part is received in said opening and said gripping member is in said contracted condition;
at least one rolling member; and
means for mounting said at least one rolling member on said gripping member.

2. The carriage of claim 1, wherein said gripping member has two ends which are spaced from one another by a first distance in said expanded condition, said ends being spaced from one another by a second distance smaller than said first distance in said contracted condition, and said mounting means including at least one bearing member attached to said gripping member in the region of one of said ends, said bearing member being provided with an aperture, and said mounting means further including a shaft receivable in said aperture and designed to support said rolling member for rotation.

3. The carriage of claim 2, wherein said mounting means includes an additional bearing member attached to said gripping member in the region of the other of said ends, said additional bearing member being provided with an additional aperture designed to receive said shaft.

4. The carriage of claim 3, further comprising an additional rolling member; and wherein each of said bearing members has a side facing away from the other of said bearing members, said shaft having a length which exceeds the distance between said bearing members in said expanded condition so that a portion of said shaft projects to each of said sides when said shaft is received in said apertures, and each of said rolling members being mountable on a respective one of said shaft portions.

5. The carriage of claim 4, wherein said mounting means comprises means for urging said gripping member from said expanded condition to said contracted condition, said urging means including a sleeve for each of said shaft portions, and each of said sleeves having a length smaller than the length of a respective shaft portion, each of said sleeves being designed to abut a respective bearing member when said sleeves are mounted on said shaft portions, and each of said rolling members being receivable on, and having a width smaller than the length of, a respective sleeve, said urging means further including an abutment receivable on each of said shaft portions and designed to bear against the respective sleeve.

6. The carriage of claim 5, wherein said urging means includes a locking member receivable on each of said shaft portions for locking said sleeves, said rolling elements and said abutments on said shaft portions, said locking members being designed to bear against said abutments.

7. The carriage of claim 6, further comprising an additional sleeve receivable on said shaft between said bearing members, said additional sleeve having a length substantially equal to the distance between said bearing members in said contracted condition.

8. The carriage of claim 1, further comprising a foot designed to cooperate with said at least one rolling member in supporting said gripping member on a surface.

9. The carriage of claim 8, further comprising a carrier for adjustably holding said foot on said gripping member.

10. The carriage of claim 9, wherein said carrier and said foot are provided with cooperating threaded portions for adjusting the position of said foot on said gripping member.

11. The carriage of claim 9, further comprising a locking member for locking said foot in different positions on said gripping member.

12. The carriage of claim 8, wherein said foot and said at least one rolling member comprise rubber to cushion said gripping member.

13. The carriage of claim 1, wherein said gripping member comprises a metallic element having a major surface which faces said opening and a deformable rubber element affixed to said major surface to adjust said gripping member to the selected part of the article.

14. The carriage of claim 1, wherein said gripping member comprises a band which is part-circular in said expanded condition.

15. A manually transportable arrangement comprising:
a container for fluid movable between an upright position and a lying position; and
a carriage for said container, said carriage including a gripping member defining an opening which receives a part of said container, and said gripping member gripping said part of said container, said carriage further including at least one rolling member and means mounting said at least one rolling member on said gripping member, and said container and said carriage being designed so that, while said gripping member grips said part of said container, said container can be in said lying position with said carriage substantially free of contact with all objects other than said container.

16. The arrangement of claim 15, wherein said gripping member extends circumferentially of said opening and is deformable between an expanded condition and a contracted condition, said opening having a first size in said expanded condition which is sufficiently large for said part of said container to enter said opening, and said opening having a second size smaller than said first size in said contracted condition, said gripping member being in said contracted condition, and said second size being selected such that said gripping member grips said part of said container, said gripping member having two ends which are spaced from one another by a first distance in said expanded condition, and said ends being spaced from one another by a second distance smaller than said first distance in said contracted condition, said mounting means including at least one bearing member attached to said gripping member in the region of one of said ends, and said bearing member being provided with an aperture, said mounting means further including a shaft which extends into said aperture and supports said at least one rolling member for rotation.

17. The arrangement of claim 16, wherein said mounting means includes an additional bearing member attached to said gripping member in the region of the other of said ends, said additional bearing member being provided with an additional aperture, and said shaft extending into said additional aperture.

18. The arrangement of claim 17, further comprising an additional rolling member; and wherein each of said bearing members has a side facing away from the other of said bearing members, said shaft having a length which exceeds the distance between said bearing members in said expanded condition so that a portion of said shaft projects to each of said sides, and each of said rolling members being mounted on a respective one of said shaft portions.

19. The arrangement of claim 18, wherein said mounting means comprises means for urging said gripping member from said expanded condition to said contracted condition, said urging means including a sleeve on each of said shaft portions, and each of said sleeves having a length smaller than the length of the respective shaft portion, each of said sleeves abutting the respective bearing member, and each of said rolling members being mounted on, and having a width smaller than the length of, a respective sleeve, said urging means further including an abutment on each of said shaft portions bearing against the respective sleeve.

20. The arrangement of claim 19, wherein said urging means includes a locking member on each of said shaft portions for locking said sleeves, said rolling elements and said abutments on said shaft portions, said locking members bearing against said abutments.

21. The arrangement of claim 20, further comprising an additional sleeve on said shaft between said bearing members, said bearing members bearing against said additional sleeve.

22. The arrangement of claim 15, further comprising a foot on said gripping member designed to cooperate with said at least one rolling member in supporting said gripping member on a surface.

23. The arrangement of claim 22, further comprising a carrier for said foot, said carrier adjustably holding said foot on said gripping member.

24. The arrangement of claim 23, wherein said carrier and said foot are provided with cooperating threaded portions for adjusting the position of said foot on said gripping member.

25. The arrangement of claim 23, further comprising a locking member for locking said foot in different positions on said gripping member.

26. The arrangement of claim 22, wherein said foot and said at least one rolling member comprise rubber to cushion said gripping member.

27. The arrangement of claim 15, wherein said gripping member comprises a metallic element having a major surface which faces said opening and a deformable rubber element affixed to said major surface to adjust said gripping member to said part of said container.

28. The arrangement of claim 15, wherein said gripping member is removable from said part of said container and comprises a band which is part-circular when said gripping member is removed from said part of said container.

29. The arrangement of claim 15, wherein said part of said container comprises a base for supporting said container on a surface when said container is in said upright position, said base having a first end and an opposite second end which is spaced from said first end by a predetermined distance, and said container having an additional part which defines a shoulder with said first end of said base, said gripping member having a length, as considered in a direction from said first end towards said second end, which is at most equal to said predetermined distance.

30. The arrangement of claim 29, wherein said gripping member abuts said shoulder.

31. The arrangement of claim 15, wherein said container has a height and said carriage extends along a minor fraction of said height.

32. The arrangement of claim 15, wherein said container has a longitudinal axis, said container having a first projection in a plane normal to said longitudinal axis and said carriage having a second projection in said plane, and at most a minor fraction of said second projection being located externally of said first projection.

33. The arrangement of claim 15, wherein said container accommodates liquid propane gas.
